(19) United States
(12) Patent Application Publication
(10) Pub. No.: US 2025/0068629 A1
(43) Pub. Date: Feb. 27, 2025

(54) EFFICIENT STORAGE AND RETRIEVAL OF SMALL OBJECTS

(71) Applicant: Tigris Data, Inc., Sunnyvale, CA (US)

(72) Inventors: Himank CHAUDHARY, Campbell, CA (US); Ovais TARIQ, Mountain View, CA (US)

(21) Appl. No.: 18/814,218

(22) Filed: Aug. 23, 2024

Related U.S. Application Data
(60) Provisional application No. 63/578,777, filed on Aug. 25, 2023.

(51) Int. Cl. G06F 16/2453; G06F 16/2457

(52) U.S. Cl. CPC G06F 16/24539; G06F 16/24573

(57) ABSTRACT

A computer implemented method for efficient storage and retrieval of small objects from metadata storage, a cache, and an object store, including inlining one or more objects in the metadata storage and coalescing one or more inlined objects for storage in the object store.

This application claims the benefit of U.S. Provisional Application No. 63/578,777, filed Aug. 25, 2023, which application is incorporated herein by reference.

### SUMMARY

Provided herein are methods and systems for efficient storage and retrieval of small objects.

In one aspect, the embodiments herein disclose a method for storing one or more objects, comprising: receiving a plurality of objects; storing the plurality of objects in a metadata storage, thereby creating a plurality of inlined objects in the metadata storage; storing at least one object of the one or more objects in a cache based on one or more properties of the at least one object; coalescing a subset of the plurality of objects to create at least one coalesced object; and storing the at least one coalesced object in an object store. In some embodiments, an inlined object of the plurality of inlined objects has a size of about 64 kibibytes (KiB) or less. In some embodiments, the coalescing the subset of the plurality of objects to create the at least one coalesced object comprises combining two or more objects of the plurality of objects into a coalesced object of the at least one coalesced object. In some embodiments, the two or more objects comprises two or more inlined objects of the plurality of inlined objects. In some embodiments, the method further comprises removing content of the two or more inlined objects from the metadata storage upon being coalesced. In some embodiments, a first coalesced object of the at least one coalesced object is associated with a bulk identifier. In some embodiments, each object of the subset of the plurality of objects is associated with the bulk identifier. In some embodiments, each object of the plurality of objects is associated with a unique identifier. In some embodiments, the method comprising modifying the metadata of the plurality of objects. In some embodiments, modifying the metadata of the plurality of objects comprises associating the bulk identifier with each object of the subset of the plurality of objects. In some embodiments, the one or more properties comprises: a date of access; or a size. In some embodiments, the date of access is the date the object was most recently accessed. In some embodiments, the storage of the cache is bounded. In some embodiments, the method further comprises removing a first object of the at least one object of the one or more objects from the cache based on the one or more properties. In some embodiments, removing the first object from the cache based on the one or more properties comprises removing the first object from the cache when the first object has not been accessed for a threshold period of time. In some embodiments, the method further comprises determining if the first object has not been accessed for the threshold period of time by comparing a timestamp of the first object to metadata associated with the first object in the metadata storage. In some embodiments, a physical memory comprises the metadata storage and the cache. In some embodiments, the object store is on a network.

In one aspect, the embodiments herein disclose a method for returning one or more objects, comprising: receiving a query comprising an identifier indicating an object; determining whether a metadata storage or a cache comprises the object based on the identifier, wherein the metadata storage comprises one or more inlined objects; if content of the object is in the metadata storage or the cache, returning at least one inlined object of the one or more inlined objects or at least one cached object of one or more cached objects associated with the identifier; if content of the object is not in the metadata storage or the cache: searching one or more coalesced objects of the object store based on the identifier; and returning at least one coalesced object of the one or more coalesced objects associated with the identifier. In some embodiments, the content of the object is in the metadata storage or the cache. In some embodiments, the content of the object is not in the metadata storage or cache. In some embodiments, an inlined object of one or more inlined objects has a size of about 64 kibibyte (KiB) or less. In some embodiments, the one or more coalesced objects are generated by combining a plurality of inlined objects stored in the metadata storage. In some embodiments, content of two or more inlined objects of the plurality of inlined objects is removed from the metadata storage upon the two or more inlined objects being combined. In some embodiments, the storage of the cache is bounded. In some embodiments, the method further comprises storing the object in the cache based on the query. In some embodiments, the method further comprises removing a cached object from the cache based on one or more properties of the cached object. In some embodiments, the one or more properties comprises: a date of access; or a size. In some embodiments, the date of access is the date the cached object was most recently accessed. In some embodiments, removing the cached object from the cache based on the one or more properties comprises removing the cached object from the cache when the cached object has not been accessed for a threshold period of time. In some embodiments, the method further comprises determining if the cached object has not been accessed for the threshold period of time by comparing a timestamp of the cached object to metadata associated with the cached object in the metadata storage. In some embodiments, the at least one coalesced object of the one or more coalesced objects is associated with the identifier. In some embodiments, a physical memory comprises the metadata storage and the cache. In some embodiments, the object store is on a network.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents and patent applications incorporated by reference contradict the disclosure contained in the specification, the specification is intended to supersede and/or take precedence over any such contradictory material.

### BRIEF DESCRIPTION OF THE DRAWINGS

The novel features of the inventive concepts are set forth with particularity in the appended claims. A better understanding of the features and advantages of the present inventive concepts will be obtained by reference to the following detailed description that sets forth illustrative embodiments, in which the principles of the inventive concepts are utilized, and the accompanying drawings (also “Figure” and “FIG.” herein), of which:

FIG. 1 shows a non-limiting example of a system for efficiently storing and retrieving one or more objects.

FIG. 2 shows a non-limiting example of a process for efficiently storing one or more objects.

FIG. 3 shows a non-limiting example of a process for efficiently retrieving one or more objects.

FIG. 4 shows a non-limiting example of the method disclosed herein for efficiently storing one or more objects.

FIG. 5 shows a non-limiting example of the method disclosed herein for efficiently retrieving one or more objects.

FIG. 6 shows a non-limiting example of a computing device with one or more processors, memory, storage, and a network interface.

FIG. 7 shows a non-limiting example of a web/mobile application provision system providing browser-based and/or native mobile user interfaces.

FIG. 8 shows a non-limiting example of a cloud-based web/mobile application provision system comprising an elastically load balanced, auto-scaling web server and application server resources as well synchronously replicated databases.

### DETAILED DESCRIPTION

As the amount of data on networks that is being retrieved and processed grows ever larger, conventional methods of storage and retrieval are becoming increasingly difficult due to the amount of space and processing resources needed to handle the processed data. Using conventional methods, objects may be individually identified, stored, and/or retrieved, and in many cases, multiple databases may need to be able to be searched to find them. As more and more objects are added to the existing databases, the amount of resources needed to store the objects as well as the amount of resources needed to search for and process them becomes untenable. For example, conventional methods often store all objects, even small objects that are 64 kibibytes (KiB) or smaller, in an object store, and the object store must be accessed to retrieve those small objects. However, retrieving the small objects from the object store requires extra processing resources, and additionally, object stores are not optimized for the storage and access of small objects, which further increases the cost of retrieving them and results in a reduction in performance.

Systems and methods as described herein overcome such deficiencies of conventional methods by efficiently storing and retrieving objects. In particular, the small objects mentioned above are more efficiently stored by utilizing metadata storage and a cache, while also maximizing the performance with respect to the object store. By “inlining” small objects in the metadata storage, content of the small objects can be kept in the metadata storage for quick access. For example, if a read request is received for the small objects that have been inlined, the content can be quickly retrieved without ever having to access the object store, thus saving both time and processing resources. The inlined objects additionally may be combined to make a “coalesced object” that is big enough for the object store to properly handle, and the coalesced object can then be placed in the object store for storage and access. A “bulk” identifier may be associated with the small objects that were combined as well as the coalesced object, making identification and retrieval from the object store efficient and easy. Even further, other objects that are too large to be coalesced and therefore can be properly handled by the object store can also be stored in the object store. Accordingly, when a read request is received, small objects that are too small for the object store to reliably handle can be found inlined in the metadata storage, and can be efficiently retrieved, while bigger objects that are the proper size for the object store can be reliably identified and returned. In addition, a cache can be used to store objects that have been recently accessed in case those objects are needed again, further reducing the amount of time and resources needed for retrieving the objects.

Accordingly, by efficiently utilizing the metadata storage and cache, as well as coalescing objects to more efficiently access object stores, the systems and methods described herein operate more efficiently and require fewer resources than conventional methods.

### Systems

Disclosed herein are embodiments for systems of efficient storage and retrieval of objects. In some embodiments, an object may include an image, video, a document (e.g., pdf, word doc, JSON document, etc.), application logs, application states, backups, machine learning models, or any random data. While some objects are listed above, these objects are exemplary and other types of objects may be used.

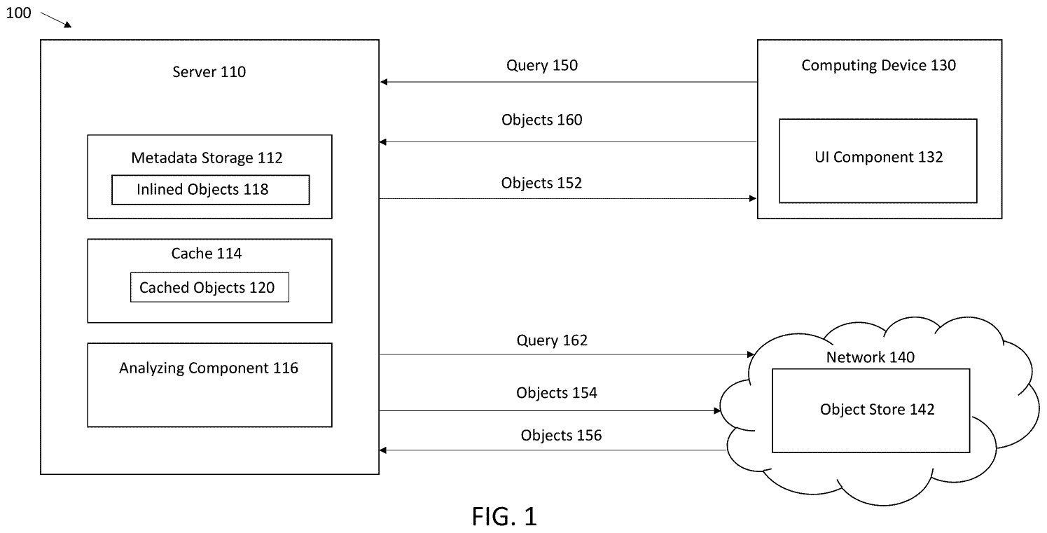

FIG. 1 depicts a non-limiting example of a computing system 100 for efficient storage and retrieval of objects. In this depicted example, system 100 includes server 110, computing device 130, and network 140.

In this depicted example, server 110 includes metadata storage 112, cache 114, and analyzing component 116. In some embodiments, the server 110 may not include metadata storage 112 and/or cache 114. In those embodiments, the metadata storage 112 and/or cache 114 may be on one or more separate processing devices. In this depicted example, metadata storage may include metadata for a plurality of objects. In this depicted example, metadata storage 112 may be configured to store inlined objects 118. In some embodiments, upon receiving an object server 110 may store the metadata of the object in metadata storage to create an inlined object. In some embodiments, the metadata of an object may include one or more key identifiers of the object, an object length, and or a pointer to the object's byte offset. In some embodiments, each object has a unique key identifier. While some metadata is described above, this is exemplary and other metadata may be used. In some embodiments, the server 110 may be configured to determine whether to store the object in the metadata storage 112 to become an inlined object of inlined objects 118. In some embodiments, the server 110 determines whether to store the object in the metadata storage 112 based on a property of the object. In some embodiments, the property of the object is a size of the object. In some embodiments, the server 110 determines an object should be inlined when the size of the object is 64 kibibytes (KiB) or less. In some embodiments, the server 110 storing the object in the metadata “inlines” the content of the object in the metadata storage (thus, making the content of the object an “inlined object” in the metadata storage 112.) In some embodiments, the inlined object is stored on a solid-state drive of the metadata storage.

In this depicted embodiment, the server 110 may be further configured to create one or more coalesced objects using analyzing component 116. In some embodiments, the one or more coalesced objects may be created from a plurality inlined objects of inlined objects 118. In some embodiments, a coalesced objects of the one or more coalesced objects is created by combining the plurality of inlined objects of inlined objects 118. In some embodiments, each coalesced object of the one or more coalesced object is associated with a respective bulk identifier. In some embodiments, each inlined object of a coalesced object is also associated with the bulk identifier of the coalesced object.

In this depicted embodiment, server 110 may be configured to provide one or more objects 154 to network 140 for storing in object store 142. The one or more objects 154 may include one or more coalesced object or one or more objects that were not coalesced. For example, if objects 160 are received by server 110, and a plurality of objects of the objects 160 are below a threshold size, the plurality of objects may be coalesced into one or more coalesced objects, while some of objects 160 are above the threshold size and thus are not coalesced. Server 110 may then provide the one or more coalesced objects and objects that are above the threshold size in objects 154 to the network 140 to store in object store 142.

In this depicted embodiments, the cache 114 of server 110 is configured to store one or more objects (e.g., making the stored objects cached objects 120). In some embodiments, the server 110 may determine whether to cache an object using analyzing component 116. In some embodiments, the server 110 may cache an object based on a property of the object. In some embodiments, the property may be a size or a date that the object was more recently accessed. For example, if a key identifier indicating a first object is received (e.g., as indicated in a query 150 received from computing device 130), the server 110 may search the object store 142 of network 140 based on the identifier. The key identifier may be used to indicate the first object, which is one object of a plurality of objects combined to create a first coalesced object, where the first coalesced object is associated with a first bulk identifier. The first coalesced object may be retrieved based on the key identifier and the first bulk identifier. After retrieving the first coalesced object, the server 110 may access the first object, and may provide the first object in response to the query 150. The server 110 may then additionally cache the first object in cache 114 based on the date of access. Accordingly server 110 may cache one or more objects based on how often or how recently the one or more objects are accessed. Since the cached objects 120 are in the cache 114 of server 110, the server 110 may be able to retrieve an object from the cache 114 rather than querying the network 140, saving both time and processing resources, and accordingly improving the efficiency of retrieving objects as opposed to conventional methods. In some embodiments, one or more objects of cached objects 120 may be removed if the one or more objects have not been accessed within a threshold time. In some embodiments, each of cached objects 120 may be associated with a timestamp indicating when the cached object was last accessed. In some embodiments, the one or more objects of the cached objects 120 being removed if the one or more objects have not been accessed within a threshold time is based on timestamps of the one or more objects.

In this depicted embodiment, computing device 130 includes user interface (UI) component 132. In some embodiments, UI component comprises a user interface. In some embodiments, UI component comprises a graphical user interface. In some embodiments, UI component comprises a programmatic user interface. In some embodiments, the user interface is capable of receiving user input. In some embodiments, the user input may be text input, touch input, sound input, or another comparable input. In some embodiments, the user input may include one or more identifiers. In some embodiments, the one or more identifiers may include one or more key identifiers or one or more bulk identifiers.

In this depicted embodiment, computing device 130 may be configured to communicate with server 110. In this depicted embodiment, server 110 may be configured to communicate with computing device 130. In this depicted embodiment, computing device may provide one or more objects 160 to the server 110. As described above, the server 110 may be configured to determine where to store the one or more objects 160. For example, the server 110 may determine that one or more of the one or more objects 160 may below a threshold size, and may determine to store those objects of the one or more objects 160 by inlining the objects, while the remainder of the one or more objects 160 are stored elsewhere (e.g., the remainder of the one or more objects 160 are provided to the network 140 to be stored on the object store 142). In this depicted embodiment, the computing device 130 may be further configured to provide a query 150. In some embodiments, the query 150 may include a read request. In some embodiments, the query 150 includes at least one identifier. In some embodiments, the at least one identifier may include a key identifier and/or a bulk identifier. In some embodiments, the server may be configured to search the metadata storage 112 and cache 114 for one or more objects based on the at least one identifier.

In this depicted embodiment, the server 110 is configured to communicate with network 140. In this depicted embodiment, the server is further configured to provide query 162 to network 140 if the server 110 determines that the metadata storage 112 and the cache 114 do not contain the one or more objects based on the at least one identifier. In some embodiments, the query 162 indicates the at least one identifier. Based on the at least one identifier, the object store 142 may be searched, and one or more objects 156 may be retrieved from the object store based on the at least one identifier (e.g., because an object or coalesced object of the object store is associated with at least one identifier).

The server 110 may be configured to provide at least one object 152 to the computing device in response to the query 150. The at least one object 152 may include one or more objects from inlined objects 118, cached objects 120, or objects 156. The at least one object 152 may include an object that is extracted from a coalesced object of objects 156. In this depicted embodiment, the at least one object 152 is associated with the at least one identifier.

While objects 152, objects, 154, objects 156, and objects 160 are described as “objects”, “one or more” objects, or “at least one” object, a person of skill in the art would recognize that the description of multiple objects is exemplary with regard to communicating objects, and that a single object may be used. For example, one object 160 may be provided to server 110, one object 154 may be provided to the network for storing in the object store, one object 156 may be retrieved from the object store 142, and/or one object 152 may be provided to the computing device 130.

In some embodiments, metadata storage 112 and/or cache 114 are not on server 110, and instead on an another device. In some embodiments, the metadata storage 112 and cache 114 are on a physical memory.

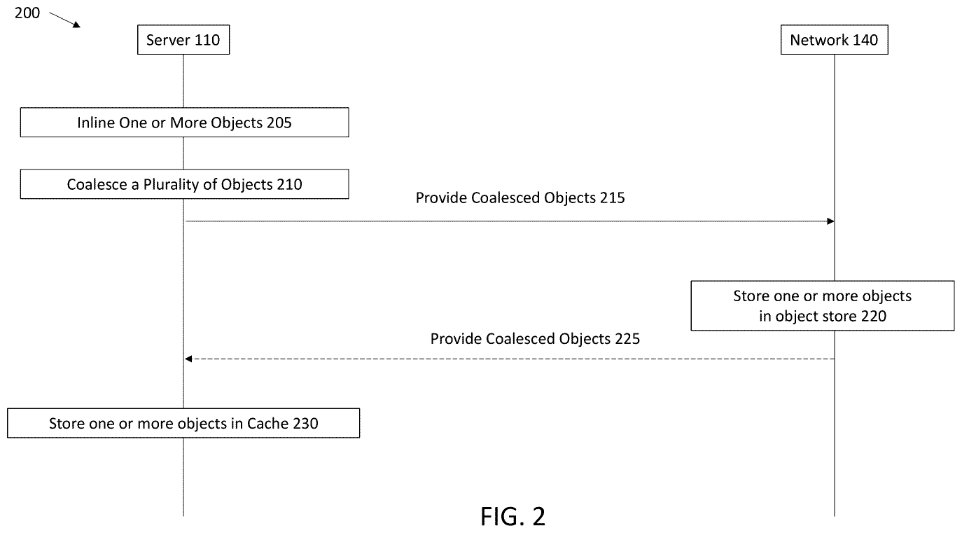

FIG. 2 depicts an example process 200 for inlining, coalescing, and storing one or more objects. In some embodiments, the process may be performed by one or more processing devices. In this depicted embodiments, the process is performed by server 110 and network 140.

Server 110 may receive one or more objects, and may determine to inline or not inline certain objects of the one or more objects based on a property of each object. The property of the object may be a size of the object. In this depicted embodiment, at 205, the server determines to inline one or more objects that are below a threshold size. In some embodiments, the inlined objects are stored in a metadata storage of the server 110 (e.g., metadata storage 112 of FIG. 1). In some embodiments, the threshold size is 64 KiB. Next, at 210, the server coalesces a plurality of the inlined objects to generate one or more coalesced objects. In some embodiments, the one or more objects and the one or more coalesced objects may be associated with various identifiers. In some embodiments, each of the received one or more objects may be associated with a unique key identifier. In some embodiments, the unique key identifier may be used to identify a specific object of the one or more objects. In some embodiments, each coalesced object of the one or more coalesced objects is associated with a bulk identifier (e.g., an identifier indicating that the coalesced object includes multiple inlined objects). In some embodiments, the bulk identifier may be used to identify the associated coalesced object and/or the inlined objects that were coalesced to generate the associated coalesced object. In some embodiments, the metadata of the inlined objects that were coalesced to generate the associated coalesced object may be modified. In some embodiments, the metadata of the inlined objects is modified by associating the inlined objects with the bulk identifier. In some embodiments, the metadata of the inlined objects is modified to associate the inlined objects with the bulk identifier as well as indicate a position of the inlined objects within the coalesced object. The position of an inlined object may comprise an offset of the inlined object within the coalesced object as well as the length of the object. For example, a first object of the coalesced object may have an offset of 0 and a length of 32,768, while a second object of the coalesced object may have an offset of 32,768 (due to the first object taking that space) and a length of 32,768, and a third object of the coalesced object may have an offset of 65,536 (due to the first object and the second object taking that space) and have a length of 32,768.

While inlined objects that are not coalesced remain on server 110, the coalesced objects are provided to the network 140 at step 215. At step 220, the coalesced objects are stored in an object store of the network 140 (e.g., object store 142 of FIG. 1). In some embodiments, objects of the server that were not inlined may be provided to the network for storing in the object store with the coalesced objects. In some embodiments, the server 110 may further associate a bulk identifier with each coalesced object before providing to the network 140. In some embodiments, each individual inlined object and each individual object that was combined into a coalesced object may be associated with a unique key identifier. In some embodiments, objects (e.g., inlined, coalesced, or otherwise) may be retrieved based on a key identifier and/or a bulk identifier. At step 225, one or more objects provided by the server 110 are stored in the object store.

In some embodiments, the server 110 may later query network 140 (e.g., using query 162 of FIG. 1). The query may comprise one or more identifiers (e.g., one or more key identifiers or one or more bulk identifiers). Objects may be retrieved from the object store based on the one or more identifiers and provided to the server 110 at step 225. Those objects may then be stored in a cache of the server 110 (e.g., cache 114 of FIG. 1) for later retrieval. In some embodiments, the objects stored in the cache may be stored based on their date of most recent access. In some embodiments, an object stored in the cache may be removed from the cache based on a timestamp indicating that an object has not been accessed in a threshold period of time. In some embodiments, if a coalesced object is accessed based on a key identifier, only objects associated with the key identifier are stored in the cache rather than the entirety of the coalesced object.

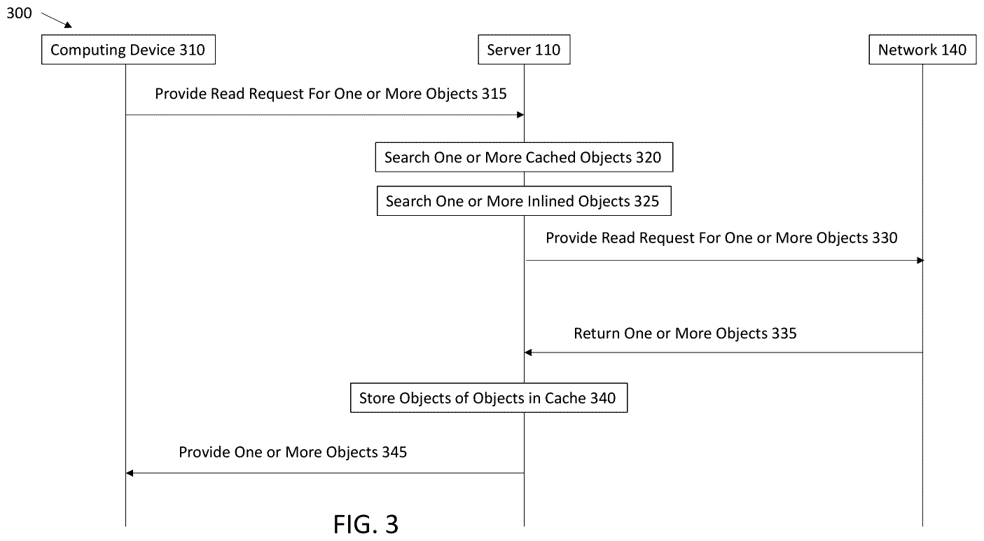

Accordingly, as described further with respect to FIG. 3, if a read request is received by the server 110 for an object, the server 110 may use an identifier included in the read request to determine which objects to return. If the identifier includes a key identifier, the server 110 may check the metadata storage and cache to determine if any objects associated with the key identifier are in the metadata storage or cache. If no content of the objects associated with the key identifier are in the metadata storage or cache, the server 110 may query the network 140 with a key identifier associated with the object. Accordingly, the key identifier may then be used to identify an object that has been coalesced into a coalesced object associated with a bulk identifier, and the bulk identifier may be used to identify and retrieve the coalesced object containing the object associated with the key identifier.

FIG. 3 depicts an example process 300 for returning one or more objects based on a read request. In this depicted embodiment, the process is performed by computing device 310, server 110, and network 140.

At step 315, the computing device 310 provides a read request including at least one identifier for one or more objects to server 110. In this depicted embodiment, the server 110 searches one or more cached objects (e.g., cached objects 120 of FIG. 1) at step 320 based on the at least one identifier to determine if one or more objects associated with the at least one identifier are stored in a cache (e.g., cache 114 of FIG. 1). In some embodiments, the at least one identifier may be a key identifier, where each cached object of the one or more cached objects is associated with a unique key identifier. In some embodiments, if all objects associated with the at least one identifier are stored in the cache alone, or the metadata storage and cache combined, the server may provide the objects associated with the identifier to the computing device, and the process would finish.

Based on the at least one identifier in the read request, the server 110 further searches one or more inlined objects (e.g., inlined objects 318 of FIG. 1) to determine if one or more objects associated with the at least one identifier are stored in metadata storage at step 325. In some embodiments, the at least one identifier may be a key identifier, where each inlined object of the one or more inlined objects is associated with a unique key identifier. In some embodiments, if all objects associated with the at least one identifier are stored in the metadata storage, or the metadata storage and cache combined, the server may provide the objects associated with the identifier to the computing device 310, and the process would finish.

In this depicted embodiment, the server 110 then provides the read request for the one or more objects to network 140 at step 330. One or more objects may be retrieved from an object store (e.g., object store 142 of FIG. 1) based on the at least one identifier and returned to the server 110 at step 335. The one or more objects may include one or more coalesced objects and/or one or more other objects (e.g., objects above a threshold size). The one or more objects may be retrieved based on the at least one identifier (e.g., a bulk identifier for coalesced objects). For example, in some embodiments, the at least one identifier may include a bulk identifier. After the server 110 checks the metadata storage and the cache and determines that not all objects associated with the key identifier are in the metadata storage or cache, the server 110 may query the network 140. The key identifier may be associated with an object that has been coalesced into a coalesced object, and/or may be associated with an additional object in the object store that was not coalesced. The object that has been coalesced also has had its metadata modified to be associated with a bulk identifier associated with the coalesced object, and the coalesced object may be retrieved using the bulk identifier after using the key identifier to identify the object that has been coalesced. The additional object that has not been coalesced may be retrieved using the key identifier. Accordingly, the objects identified using the at least one identifier may then be retrieved.

In this depicted embodiment, the server 110 then stores one or more objects in the cache at step 340. In some embodiments, the server 110 may store the one or more objects in the cache. In some embodiments, the server 110 may store one or more coalesced objects in the cache. In some embodiments, the server 110 may store one or more objects that had been combined to form a coalesced object. In some embodiments, the server 110 may store the one or more other objects. In some embodiments, the objects stored in the cache may later be removed if the objects are not accessed again during a threshold time period, as described above.

In this depicted embodiment, the server 110 then provides the one or more objects (e.g., inlined objects, cached objects, other objects, and/or coalesced objects) associated with the at least one identifier indicated in the read request to the computing device 310 at step 345. In some embodiments, the computing device 310 may include a user interface component for displaying one or more of the received objects and/or one or more properties of the received objects.

### Example Method for Storing One or More Objects

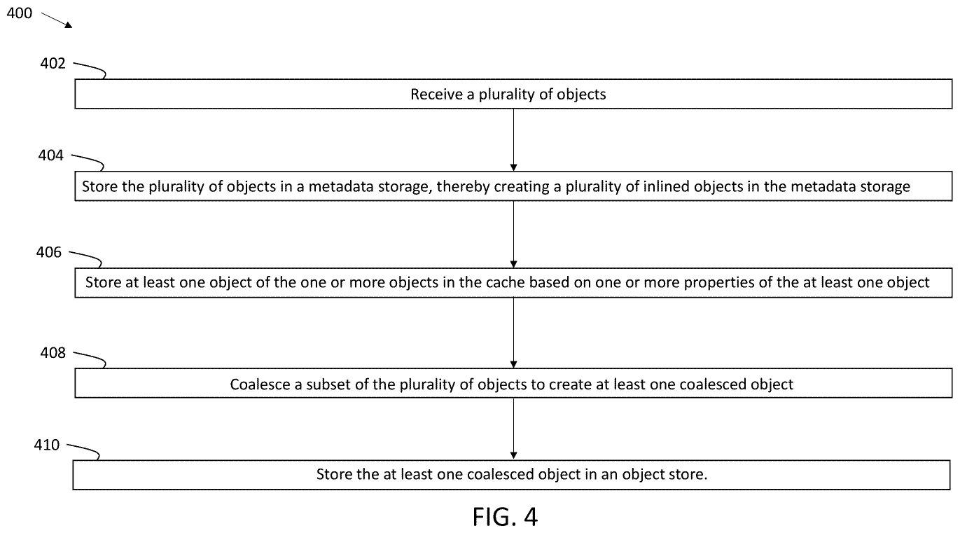

FIG. 4 depicts an example method 400 for efficient storage of one or more objects (e.g., as described above with respect to FIGS. 1-2). In some embodiments, at least a portion of the method is performed by one or more processing devices (e.g., server 110 of FIGS. 1-2).

The method begins at step 402, where a plurality of objects are received (e.g., objects 160 of FIG. 1). The plurality of objects may be provided by another processing device. In some embodiments, the plurality of objects may already be present on the server. In some embodiments, additional objects may be received in addition to the plurality of objects.

At step 404, the plurality of objects are stored in a metadata storage, thereby creating a plurality of inlined objects. In some embodiments, the plurality of objects may be inlined based on a property of each object of the plurality of objects. In some embodiments, the property is a size of the object. In some embodiments, an object of the plurality of objects is inlined if the size of the object is equal to or below 64 KiB. In some embodiments, the additional objects that are received may not be inlined based on a properties of the additional objects. In those embodiments, an additional object may not be inlined if a size of the additional object is above 64 KiB. In some embodiments, each of the plurality of objects is associated with a unique key identifier.

At step 406, at least one object of the plurality of objects is stored in a cache based on one or more properties of the at least one object. In some embodiments, the one or more properties includes a size of the at least one object or the date of most recent access of the at least one object. In some embodiments, the at least one object is stored in the cache after being accessed from the object store. In some embodiments, the at least one object is associated with a timestamp indicating a date the at least one object was most recently accessed. In some embodiments, an object of the at least one object may be removed from the cache for not being accessed within a threshold time period based on the timestamp.

At step 408, a subset of the plurality of objects are coalesced to create at least one coalesced object. In some embodiments, the subset of the plurality of objects includes two or more inlined objects. In some embodiments, the metadata of each object of the subset of the plurality of objects is modified. In some embodiments, the metadata is modified by associating an identifier with each of the objects. In some embodiments, each coalesced object of the at least one coalesced object is associated with a bulk identifier. In some embodiments, each of the subset of the plurality of objects is also associated with the bulk identifier.

At step 410, the at least one coalesced object is stored in an object store. In some embodiments, the object store is on a network (e.g., network 140 of FIGS. 1-3).

### Example Method for Retrieval of One or More Objects

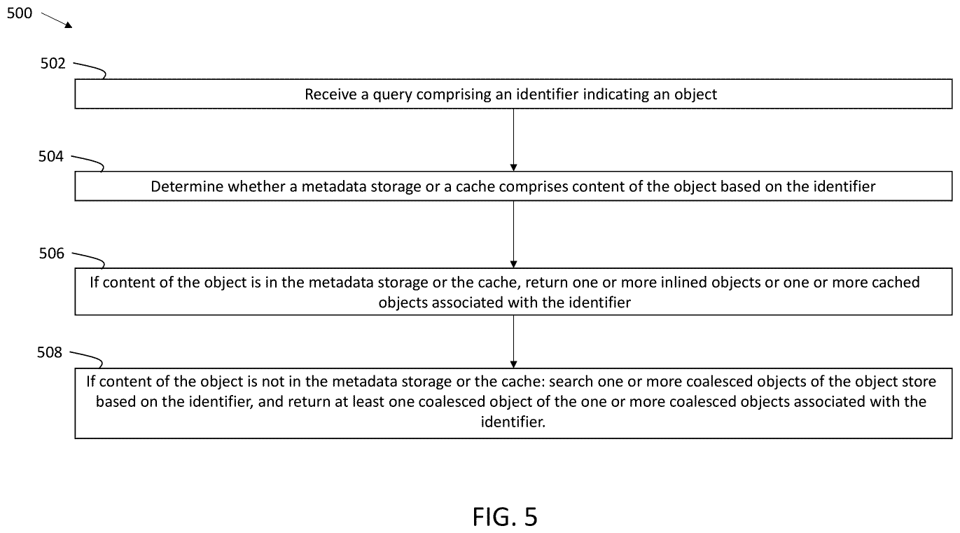

FIG. 5 depicts an example method 500 for efficient retrieval of one or more objects (e.g., as described above with respect to FIGS. 1 and 3). In some embodiments, at least a portion of the method is performed by one or more processing devices (e.g., server 110 of FIGS. 1 and 3, computing device 130 of FIG. 1, and/or computing device 310 of FIG. 3).

At step 502, a query including an identifier indicating an object is received. In some embodiments, the query may include a read request. The identifier may be a key identifier, as described above. In some embodiments, more than one identifier may be received. In those embodiments, more than one object may be indicated by the more than one identifier.

At step 504, a metadata storage and a cache are searched to determine whether the metadata storage and/or the cache comprise the content of the object based on the identifier. In some embodiments, one or more objects in the metadata storage may be inlined objects. In some embodiments, each object in the metadata storage and each object in the cache may be associated with a unique key identifier. In some embodiments, the identifier included in the query may be a unique key identifier associated with an object in the metadata storage or cache. In some embodiments, inlined objects have a size of 64 KiB or less. In some embodiments, the cache may be searched before the metadata storage.

At step 506, if it is determined, based on the identifier, that the content of the object is in the metadata storage or the cache, one or more inlined objects from the metadata storage or one or more cached objects from the cache are returned based on the returned objects being associated with the identifier.

At step 508, if it determined, based on the identifier, that the content of the object is not in the metadata storage or the cache, one or more coalesced objects of an object store are searched, and at least one coalesced object is returned based on the at least one coalesced object being associated with the identifier. In some embodiments, the objects that are coalesced into a coalesced object may have their metadata modified to cause the objects that are coalesced to be associated with a bulk identifier associated with the coalesced object. Accordingly, in some embodiments, the key identifier may be used to identify an object within a coalesced object. The object within the coalesced object will also be associated with the bulk identifier of the coalesced object. The bulk identifier may then be used to retrieve the coalesced object including the object. Thus, the identifier may be used to return the one or more identified objects.

In some embodiments, the returned objects may be stored in the cache. In some embodiments, the returned objects may be stored in a cache based on a property of the returned objects. In some embodiments, the property is a size of a returned object or the most recent date of access of a returned object. In some embodiments, a returned object may be associated with a time stamp indicating the most recent date of access. In some embodiments, a returned object is removed from the cache based on the returned object not being access for a threshold period of time.

In some embodiments, the returned objects may be provided to a computing device. In some embodiments, the computing device may display content of the object on a user interface.

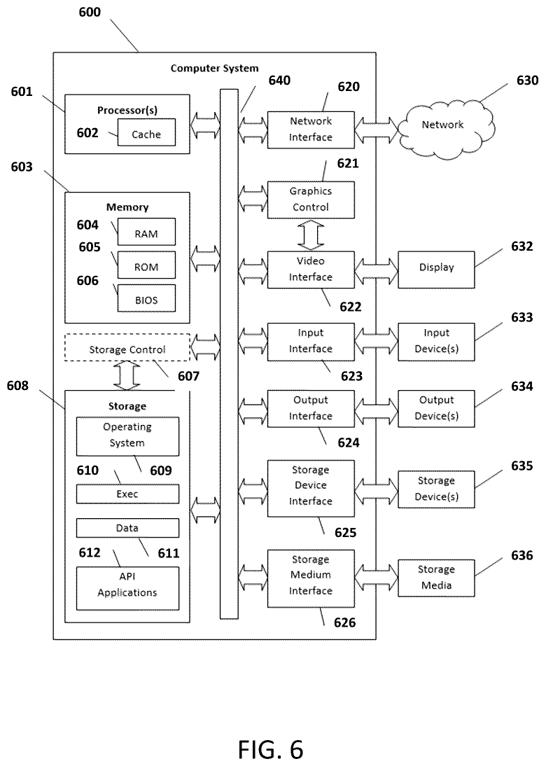

Referring to FIG. 6, a block diagram is shown depicting an exemplary machine that includes a computer system 600 (e.g., a processing or computing system) within which a set of instructions can execute for causing a device to perform or execute any one or more of the aspects and/or methodologies for static code scheduling of the present disclosure. The components in FIG. 6 are examples only and do not limit the scope of use or functionality of any hardware, software, embedded logic component, or a combination of two or more such components implementing particular embodiments.

Computer system 600 may include one or more processors 601, a memory 603, and a storage 608 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 600 includes one or more processor(s) 601 (e.g., central processing units (CPUs), general purpose graphics processing units (GPGPUs), or quantum processing units (QPUs)) that carry out functions. Processor(s) 601 optionally contains a cache memory unit 602 for temporary local storage of instructions, data, or computer addresses. Processor(s) 601 are configured to assist in execution of computer readable instructions. Computer system 600 may provide functionality for the components depicted in FIG. 6 as a result of the processor(s) 601 executing non-transitory, processor-executable instructions embodied in one or more tangible computer-readable storage media, such as memory 603, storage 608, storage devices 635, and/or storage medium 636. The computer-readable media may store software that implements particular embodiments, and processor(s) 601 may execute the software. Memory 603 may read the software from one or more other computer-readable media (such as mass storage device(s) 635, 636) or from one or more other sources through a suitable interface, such as network interface 620. The software may cause processor(s) 601 to carry out one or more processes or one or more steps of one or more processes described or illustrated herein. Carrying out such processes or steps may include defining data structures stored in memory 603 and modifying the data structures as directed by the software.

The memory 603 may include various components (e.g., machine readable media) including, but not limited to, a random access memory component (e.g., RAM 604) (e.g., static RAM (SRAM), dynamic RAM (DRAM), ferroelectric random access memory (FRAM), phase-change random access memory (PRAM), etc.), a read-only memory component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 608 provides additional data storage capacity and may also include any suitable tangible computer-readable media described herein. Storage 608 may be used to store operating system 609, executable(s) 610, data 611, applications 612 (application programs), and the like. Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide non-volatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, distributed computing systems, cloud storage systems, cloud computing systems, and the like, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 630, may employ a wired and/or a wireless mode of communication. In general, any network topology may be used.

Information and data can be displayed through a display 632. Examples of a display 632 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 632, computer system 600 may include one or more other peripheral output devices 634 including, but not limited to, an audio speaker, a printer, a storage device, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google Android®, Microsoft Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast, Amazon Fire®, and Samsung® HomeSync®. Those of skill in the art will also recognize that suitable video game console operating systems include, by way of non-limiting examples, Sony® PS3®, Sony® PS4®, Sony PS5®, Microsoft® Xbox 360™, Microsoft® Xbox One, Microsoft® Xbox Series X, Microsoft® Xbox Series S, Nintendo® Wii®, Nintendo® Wii U®, Nintendo® Switch™, and Ouya®.

Another aspect of the disclosure herein describes a non-transitory, computer-readable medium comprising executable instructions, wherein when a processor, when executing the executable instructions, performs a method as described herein.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion™, Perl, Java™, JavaServer Pages (JSP), Hypertext Preprocessor (PHP), Python™, Ruby, Tcl, Smalltalk, WebDNAK, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

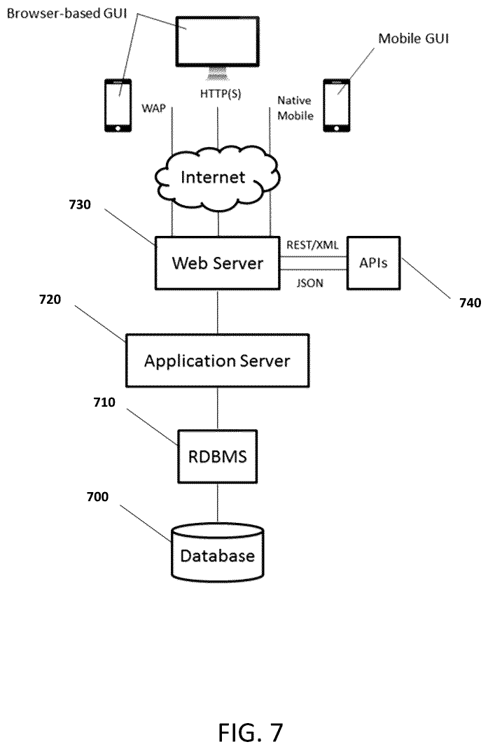

Referring to FIG. 7, in a particular embodiment, an application provision system comprises one or more databases 700 accessed by a relational database management system (RDBMS) 710. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 720 (such as Java servers, .NET servers, PHP servers, and the like) and one or more web servers 730 (such as Apache, IIS, GWS and the like). The web server(s) optionally expose one or more web services via app application programming interfaces (APIs) 740. Via a network, such as the Internet, the system provides browser-based and/or mobile native user interfaces.

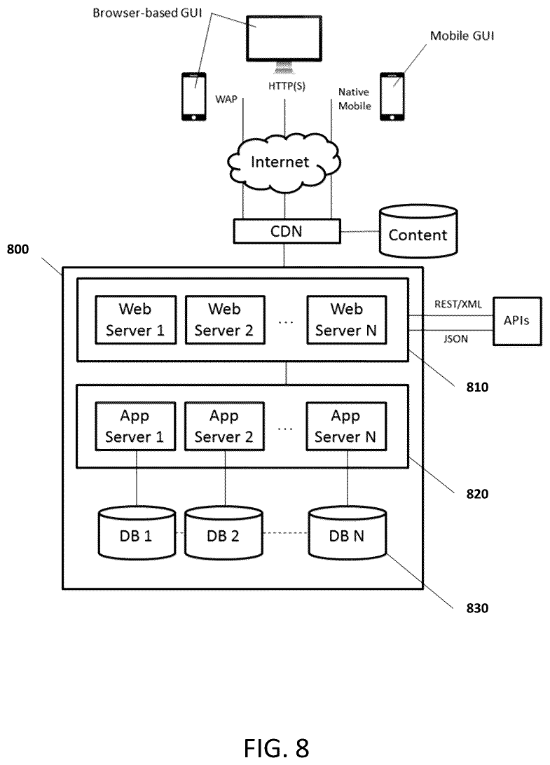

Referring to FIG. 8, in a particular embodiment, an application provision system alternatively has a distributed, cloud-based architecture 800 and comprises elastically load balanced, auto-scaling web server resources 810 and application server resources 820 as well synchronously replicated databases 830.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, Rails, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox for mobile, Microsoft® Internet Explorer® Mobile, Amazon® Kindle® Basic Web, Nokia® Browser, Opera Software® Opera Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of objects, metadata, or any combination thereof. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Data Transmission

The subject matter described herein, including methods and systems as described herein and may be configured to be performed in one or more facilities at one or more locations. Facility locations are not limited by country and include any country or territory. In some instances, one or more steps are performed in a different country than another step of the method. In some embodiments, one or more method steps involving a computer system are performed in a different country than another step of the methods provided herein. In some embodiments, data processing and storage are performed in a different country or location than one or more steps of the methods described herein. In some embodiments, one or more products or data are transferred from one or more of the facilities to one or more different facilities for analysis or further analysis. Data includes, but is not limited to, information regarding the stratification of a subject, and any data produced by the methods disclosed herein. In some embodiments of the methods and systems described herein, the subject information is compiled, and a subsequent data transmission step will transmit or store the subject information.

In some embodiments, any step of any method described herein is performed by a software program or module on a computer. In additional or further embodiments, data from any step of any method described herein is transferred to and from facilities located within the same or different countries, including analysis performed in one facility in a particular location and the data shipped to another location or directly to an individual in the same or a different country. In additional or further embodiments, data from any step of any method described herein is transferred to and/or received from a facility located within the same or different countries, including analysis of a data input, such as queries, objects, properties, types, filters, tables, or any combination thereof, performed in one facility in a particular location and corresponding data transmitted to another location.

### Business Methods Utilizing a Computer

The methods described herein may utilize one or more computers. The computer may be used for managing customer and subject information. The computer may include a monitor or other user interface for displaying data, results, billing information, marketing information (e.g. demographics), customer information, or sample information. The computer may also include means for data or information input. The computer may include a processing unit and fixed or removable media or a combination thereof. The computer may be accessed by a user in physical proximity to the computer, for example via a keyboard and/or mouse, or by a user that does not necessarily have access to the physical computer through a communication medium such as a modem, an internet connection, a telephone connection, or a wired or wireless communication signal carrier wave. In some cases, the computer may be connected to a server or other communication device for relaying information from a user to the computer or from the computer to a user. In some cases, the user may store data or information obtained from the computer through a communication medium on media, such as removable media. It is envisioned that data relating to the methods can be transmitted over such networks or connections for reception and/or review by a party.

The entity entering or reviewing information into a database for the purpose of one or more of the following: inventory tracking, order tracking, customer management, customer service, billing, and sales. Sample information may include, but is not limited to: customer name, unique customer identification, or any information suitable for storage in a database.

The database may be accessible by a user. Database access may take the form of electronic communication such as a computer or telephone. The database may be accessed through an intermediary such as a customer service representative, business representative, or consultant. The availability or degree of database access may change upon payment of a fee for products and services rendered or to be rendered.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

### EXAMPLES

The following examples are included for illustrative purposes only and are not intended to limit the scope of the inventive concepts.

### Example 1: System for Efficient Storage of Objects

A processing device configured to communicate with a network is acquired. The processing device includes a memory comprising metadata storage and a cache. The processing device receives a fifty objects for storage. Twenty-five of the fifty objects are “small objects” (e.g., 64 KiB or smaller in size), while the other twenty-five of the fifty objects are “large objects” (e.g., larger than 64 KiB). Each of the fifty objects is associated with a unique key identifier.

The system initially stores all fifty objects in the metadata storage. Each of the twenty-five small objects are processed in order to inline those objects in the metadata storage, while the twenty-five large objects are not inlined. The system then coalesces many of the small objects to create coalesced objects: (1) three small objects of sizes 32 KiB, 32 KiB, and 16 KiB are coalesced to create a first coalesced object, (2) six small objects, each having a size of 16 KiB, are coalesced into a second coalesced object, (3) five small objects of sizes 32 KiB, 16 KiB, 16 KiB, 16 KiB, and 16 KiB are coalesced into a third coalesced object, and (4) three small objects, each having a size of 32 KiB are coalesced into a fourth small object. The metadata of the small objects that are coalesced is modified to indicate a bulk identifier associated with the respective coalesced object and is also modified to indicate an offset within the coalesced object and length of the object.

Each of the coalesced objects, along with the twenty-five large objects, are provided to an object store for storage. The remaining eight small objects remain inlined in the metadata storage.

### Example 2: System for Retrieval of Small Objects

The system of Example 1 is first acquired. A read request including a first key identifier is sent by a computing device and received by the processing device. The processing device first searches the metadata storage for an object associated with the first key identifier. The processing device identifies a first inlined object of the eight remaining inlined objects as being associated with the first key identifier. The processing device retrieves the first inlined object and provides the first inlined object to the computing device in response to the read request.

### Example 3: System for Retrieval of Coalesced Objects

The system of Example 1 is first acquired. A read request including a first key identifier is sent by a computing device and received by the processing device. The processing device first searches the cache for an object associated with the first key identifier, and determines that no objects associated with the first key identifier are in the cache. The processing device then searches the metadata storage for an object associated with the first key identifier, and determines that no content of objects associated with the first key identifier are in the metadata storage. The system then reviews the metadata of the inlined objects that were coalesced, and identifies a first bulk identifier associated with the first coalesced object, which contains the object associated with the first key identifier.

The processing then queries a network comprising the object store with a first bulk identifier. The first coalesced object is retrieved from the object store using the first bulk identifier and returned to the processing device. The processing device then extracts the object associated with the first key identifier and provides the object associated with the first key identifier to the computing device in response to the read request.

### Example 4: System for Storage of Cached Objects

The system of Example 3 is first acquired. The object associated with the first key identifier is associated with a timestamp indicating when the object was accessed. The processing device stores the object associated with the first key identifier for having been accessed within a threshold period of time.

### Example 5: System for Retrieval of Cached Objects

The system of Example 4 is first acquired. A read request including a first key identifier is sent by a computing device and received by the processing device. The processing device first searches the cache for an object associated with the first key identifier, and identifies the object associated with the first key identifier in the cache. The processing device retrieves the object associated with the first key identifier and provides the object to the computing device in response to the read request.

While preferred embodiments of the present subject matter have been shown and described herein, it will be obvious to those skilled in the art that such embodiments are provided by way of example only. It is not intended that the subject matter described herein be limited by the specific examples provided within the specification. While the present subject matter has been described with reference to the aforementioned specification, the descriptions and illustrations of the embodiments herein are not meant to be construed in a limiting sense. Numerous variations, changes, and substitutions will now occur to those skilled in the art without departing from the subject matter described herein. Furthermore, it shall be understood that all aspects of the present subject matter are not limited to the specific depictions, configurations or relative proportions set forth herein which depend upon a variety of conditions and variables. It should be understood that various alternatives to the embodiments of the subject matter described herein may be employed in practice. It is therefore contemplated that the present subject matter shall also cover any such alternatives, modifications, variations or equivalents. It is intended that the following claims define the scope of the present subject matter and that methods and structures within the scope of these claims and their equivalents be covered thereby.

What is claimed is:

1. A system, comprising:
at least one memory comprising a metadata storage and a cache; and
one or more processors;
wherein the at least one memory comprises computer-readable instructions which,
when executed, cause the one or more processors to cause the system to:
receive a plurality of objects;
store the plurality of objects in the metadata storage, thereby creating a plurality of inlined objects in the metadata storage;
store at least one object of the one or more objects in the cache based on one or more properties of the at least one object;
coalesce a subset of the plurality of objects to create at least one coalesced object; and
store the at least one coalesced object in an object store.

2. The system of claim 1, wherein an inlined object of the plurality of inlined objects has a size of about 64 kibibytes (KiB) or less.

3. The system of claim 1, wherein the one or more processors being configured to cause the system to coalesce the subset of the plurality of objects to create the at least one coalesced object comprises the one or more processors being configured to cause the system to combine two or more objects of the plurality of objects into a coalesced object of the at least one coalesced object.

4. The system of claim 3, wherein the two or more objects comprises two or more inlined objects of the plurality of inlined objects.

5. The system of claim 4, wherein one or more processors are further configured to remove content of the two or more inlined objects from the metadata storage upon being coalesced.

6. The system of any one of claim 1, wherein a first coalesced object of the at least one coalesced object is associated with a bulk identifier.

7. The system of any one of claim 1, wherein each object of the plurality of objects is associated with a unique identifier.

8. The system of any one of claim 1, wherein the one or more processors are further configured to cause the system to modify metadata of the plurality of objects.

9. The system of any one of claim 1, wherein the one or more properties comprises:
a. a date of access; or
b. a size.

10. The system of claim 9, wherein the date of access is the date the object was most recently accessed.

11. The system of any one of claim 1, wherein the one or more processors are further configured to cause the system to remove a first object of the at least one object of the one or more objects from the cache based on the one or more properties.

12. The system of any one of claim 1, wherein the object store is on a network.

13. A method for storing one or more objects, comprising:
a. receiving a plurality of objects;
b. storing the plurality of objects in a metadata storage, thereby creating a plurality of inlined objects in the metadata storage;
c. storing at least one object of the one or more objects in a cache based on one or more properties of the at least one object;
d. coalescing a subset of the plurality of objects to create at least one coalesced object; and
e. storing the at least one coalesced object in an object store.

14. The method of claim 13, wherein the coalescing the subset of the plurality of objects to create the at least one coalesced object comprises combining two or more objects of the plurality of objects into a coalesced object of the at least one coalesced object.

15. The method of claim 14, wherein the two or more objects comprises two or more inlined objects of the plurality of inlined objects.

16. The method of claim 15, further comprising removing content of the two or more inlined objects from the metadata storage upon being coalesced.

17. The method of any one of claim 13, wherein a first coalesced object of the at least one coalesced object is associated with a bulk identifier.

18. The method of any one of claim 13, wherein each object of the plurality of objects is associated with a unique identifier.

19. The method of any one of claim 13, further comprising removing a first object of the at least one object of the one or more objects from the cache based on the one or more properties.

20. A non-transitory, computer-readable medium comprising executable instructions, wherein when one or more processors, when executing the executable instructions, perform a method for storing one or more objects, the method comprising:
a. receiving a plurality of objects;
b. storing the plurality of objects in a metadata storage, thereby creating a plurality of inlined objects in the metadata storage;
c. storing at least one object of the one or more objects in a cache based on one or more properties of the at least one object;
d. coalescing a subset of the plurality of objects to create at least one coalesced object; and
e. storing the at least one coalesced object in an object store.
